(19) United States
(12) Patent Application Publication
(10) Pub. No.: US 2024/0276452 A1
(43) Pub. Date: Aug. 15, 2024

(54) PAGING

(71) Applicant: Nokia Technologies Oy, Espoo (FI)

(72) Inventors: Srinivasan SELVAGANAPATHY, Bangalore (IN); Jeroan WIGARD, Aalborg (DK); Mads LAURIDSEN, Aalborg (DK); Rapeepat RATASUK, Naperville, IL (US); Ping YUAN, Beijing (CN)

(21) Appl. No.: 18/693,493

(22) PCT Filed: Oct. 20, 2021
(86) PCT No.: PCT/CN2021/125081

§ 371 Date: Mar. 19, 2024

(51) Int. Cl. H04W 68/02

(52) U.S. Cl. CPC H04W 68/02

(57) ABSTRACT

Embodiments of the present disclosure relate to paging. A first device in a tracking area receives, from a second device, identification information for monitoring a paging message associated with the tracking area. The first device is registered in the tracking area. The first device monitors, from the second device, the paging message based on the received identification information.

### FIELD

Embodiments of the present disclosure generally relate to the field of telecommunication and in particular, to devices, methods, apparatus and computer readable storage media for paging.

### BACKGROUND

As part of New Radio Non-Terrestrial Network (NR-NTN) and Internet of Things (IoT)-NTN study and work items in Release 17, for Low Earth Orbiting (LEO) satellite deployments with moving cell scenario, earth fixed tracking area (TA) concept is agreed as basis for tracking area management. In case of earth fixed tracking area, for the cells which are passing through a border of tracking areas, multiple options for change of tracking area in a cell were proposed. Among the multiple options, “soft switch” of TA is agreed as an option to minimize impact to a terminal device in an idle mode. In this option, one cell broadcasts more than one tracking area codes (TACs) when it is crossing a border of TAs. Later, the cell is changed to broadcast a single TAC when completely moving inside the tracking area. For NTN scenario where “soft switch” of TA is configured, there would be false wake-up for the terminal device in the idle mode due to paging load of all TAs.

### SUMMARY

In general, example embodiments of the present disclosure provide a solution for paging.

In a first aspect, there is provided a first device in a tracking area. The first device comprises at least one processor and at least one memory including computer program codes. The at least one memory and the computer program codes are configured to, with the at least one processor, cause the first device to: receive, from a second device, identification information for monitoring a paging message associated with the tracking area, the first device being registered in the tracking area; and receive, from the second device, the paging message based on the received identification information.

In a second aspect, there is provided a second device. The second device comprises at least one processor and at least one memory including computer program codes. The at least one memory and the computer program codes are configured to, with the at least one processor, cause the second device to: transmit, to a first device in a tracking area, an identification information for monitoring a paging message associated with the tracking area, the first device being registered in the tracking area; and transmit, to the first device, the paging message based on the identification information.

In a third aspect, there is provided a third device. The third device comprises: at least one processor; and at least one memory including computer program codes. The at least one memory and the computer program codes are configured to, with the at least one processor, cause the third device to receive, from a first device in a tracking area, an indication that the first device has capability for receiving identification information based on the tracking area, the identification information being used for monitoring a paging message associated with the tracking area, the first device being registered in the tracking area with a second device; and transmit, to the first device, an indication that the receiving of the identification information is activated.

In a fourth aspect, there is provided a method implemented at a first device. The method comprises: receiving, from a second device, identification information for monitoring a paging message associated with the tracking area, the first device being registered in the tracking area; and monitoring, from the second device, the paging message based on the received identification information.

In a fifth aspect, there is provided a method implemented at a second device. The method comprises: transmitting, to a first device in a tracking area, identification information for monitoring a paging message associated with the tracking area, the first device being registered in the tracking area; and transmitting, to the first device, the paging message based on the identification information.

In a sixth aspect, there is provided a method implemented at a third device. The method comprises: receiving, from a first device in a tracking area, an indication that the first device has capability for receiving identification information based on the tracking area, the identification information being used for monitoring a paging message associated with the tracking area, the first device being registered in the tracking area with a second device; and transmitting, to the first device, an indication that the receiving of the identification information is activated.

In a seventh aspect, there is provided a first apparatus. The first apparatus comprises: means for receiving, from a second device, identification information for monitoring a paging message associated with the tracking area, the first device being registered in the tracking area; and means for monitoring, from the second device, the paging message based on the received identification information.

In an eighth aspect, there is provided a second apparatus. The second apparatus comprises: means for transmitting, to a first device in a tracking area, identification information for monitoring a paging message associated with the tracking area, the first device being registered in the tracking area; and means for transmitting, to the first device, the paging message based on the identification information.

In a ninth aspect, there is provided a third apparatus. The third apparatus comprises: means for receiving, from a first device in a tracking area, an indication that the first device has capability for receiving identification information based on the tracking area, the identification information being used for monitoring a paging message associated with the tracking area, the first device being registered in the tracking area with a second device; and means for transmitting, to the first device, an indication that the receiving of the identification information is activated.

In a tenth aspect, there is provided a non-transitory computer readable medium. The non-transitory computer readable medium comprises program instructions for causing an apparatus to perform the method according to the fourth, fifth or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example TAC fluctuation at a border of a TA;

FIG. 2 illustrates an example communication network in which embodiments of the present disclosure may be implemented;

FIG. 3 illustrates a signaling chart illustrating a process for paging according to some example embodiments of the present disclosure;

FIG. 4 illustrates a flowchart of a method implemented at a first device according to some example embodiments of the present disclosure;

FIG. 5 illustrates a flowchart of a method implemented at a second device according to some example embodiments of the present disclosure;

FIG. 6 illustrates a flowchart of a method implemented at a third device according to some example embodiments of the present disclosure;

FIG. 7 illustrates a simplified block diagram of an apparatus that is suitable for implementing embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

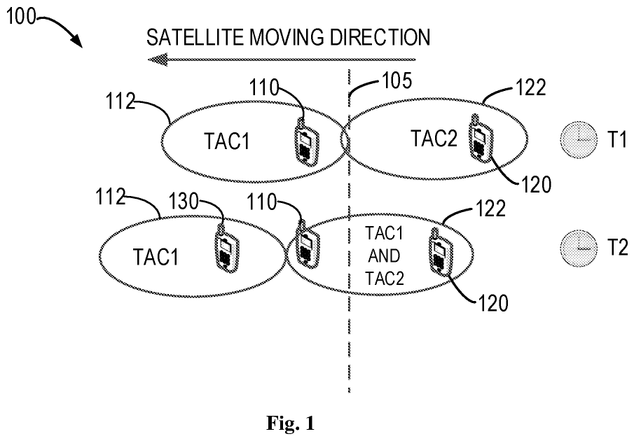

As mentioned above, for NTN scenario where “soft switch” of TA is configured, there would be false wake-up of the terminal device in the idle mode due to paging load of all TAs. This will be described with reference to FIG. 1.

FIG. 1 illustrates an example TAC fluctuation at a border of a TA. At time T1, a first terminal device 110 in an idle mode is served by in a first cell 112 broadcasting a code of a first TA. The code of the first TA is also referred to as TAC1. In addition, at time T1, a second terminal device 120 is served by a second cell 122 broadcasting a code of a second TA. The code of the second TA is also referred to as TAC2.

As a satellite moves in a satellite moving direction, the second cell 122 moves within a border 105 of the first TA and “soft switch” of TA is performed in the second cell 122. Upon the “soft switch”, at time T2, the second cell 122 broadcasts TAC1 and TAC2.

In addition, at time T2, the first terminal device 110 reselects to the second cell 122, but the first terminal device 110 performs no tacking area update (TAU). The second terminal device 120 remains in the second cell 122. A third terminal device 130 is located in the first cell 112. The second cell 122 now is a serving cell for the first terminal device 110 and the second terminal device 120. However, the first terminal device 110 and the second terminal device 120 belong to different TAs. In other words, the first terminal device 110 belongs to the first TA and the second terminal device 120 belongs to the second TA.

Upon the “soft switch”, paging escalation of the first terminal device 110 and the second terminal device 120 will be transmitted via the second cell 122. Both the first terminal device 110 and the second terminal device 120 need to receive a paging message to determine whether the paging message comprises its identity. A paging load of the second cell 122 corresponds to TA level paging. If a paging message for the first TA is directed to the third terminal device 130, the paging message will be transmitted in the second cell 122 although the third terminal device 130 is not served by the second cell 122. Thus, the paging load of the second cell 122 increases compared to a scenario where the second cell 122 serves a single TA. In addition, the first terminal device 110 and the second terminal device 120 in the second cell 122 need to wake up to monitor the paging message directed to the third terminal device 130. In other words, false wake-up of the first terminal device 110 and the second terminal device 120 occurs.

Moreover, large NTN cell broadcasting multiple codes of small TAs have the same problem.

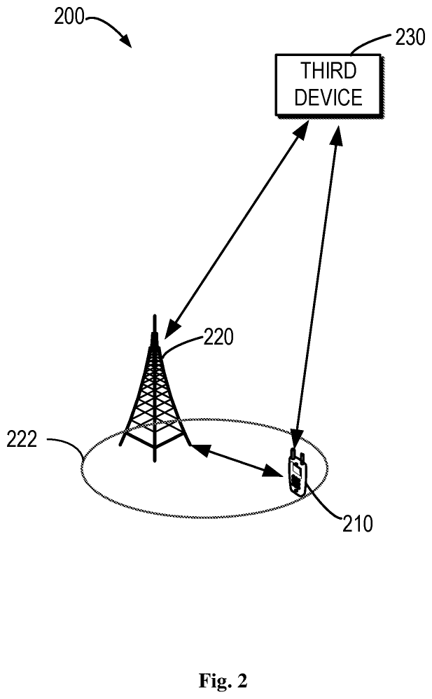

In order to solve the above and other potential problems, embodiments of the present disclosure provide an improved solution for paging. In the solution, a first device in a tracking area receives, from a second device, identification information for monitoring a paging message associated with the tracking area. The first device is registered in the tracking area. In turn, the first device monitors, from the second device, the paging message based on the received identification information. In this way, false wake-up of the first device may be avoided. Principle and implementations of the present disclosure will be described in detail below with reference to FIGS. 2 to 6.

FIG. 2 illustrates an example communication network 200 in which embodiments of the present disclosure can be implemented. As shown in FIG. 2, the communication network 200 comprises a first device 210, a second device 220 and a third device 230.

In some embodiments, the network 200 may be implemented as an NTN.

In this example, only for ease of discussion, the first device 210 is illustrated as a terminal device and the second device 220 is illustrated as an access network device serving the terminal device 210. For example, the first device 210 may be implemented as the terminal device 110, 120 or 130. For example, the second device 220 may be implemented as a base station in an access network. Thus, the serving area of the second device 220 is called a cell 222. The cell 222 may be referred to as a serving cell of the first device 210. For example, the cell 222 may be implemented as the cell 122 in FIG. 1.

It is to be understood that the terminal device and the base station are only example implementations of the first device 210 and the second device 220, respectively, without suggesting any limitation as to the scope of the present application. Any other suitable implementations are possible as well.

In some embodiments, the third device 230 may be implemented as a core network device. For example, the third device 230 may be implemented as an Anchor Mobility Function (AMF) in a core network or a Mobility Management Entity (MME) in the core network.

It is to be understood that the number of the first, second and third devices and the number of cells as shown in FIG. 2 are only for the purpose of illustration without suggesting any limitations. The network 200 may include any suitable number of first, second and third devices as well as cells adapted for implementing embodiments of the present disclosure.

The communications in the network 200 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

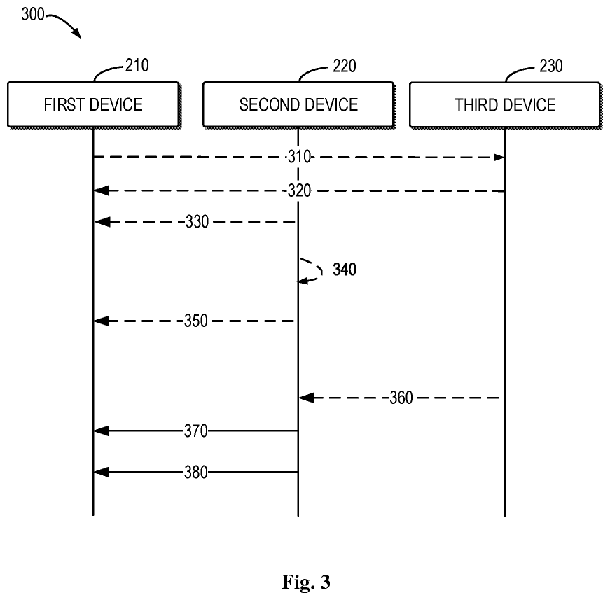

FIG. 3 shows a signaling chart illustrating a process 300 for paging according to some example embodiments of the present disclosure. For the purpose of discussion, the process 300 will be described with reference to FIG. 2. The process 300 may involve the first device 210, the second device 220 and the third device 230 as illustrated in FIG. 2. Although the process 300 has been described in the communication network 200 of FIG. 2, this process may be likewise applied to other communication scenarios.

As shown in FIG. 3, the first device 210 in a TA receives (370), from the second device 220, identification information for monitoring a paging message associated with the TA. The first device 110 is registered in the TA. For example, the identification information may correspond to the TA. Upon receiving the identification information, the first device 210 may determine, based on the identification information, whether the paging message is directed to the TA.

In some embodiments, the identification information may indicate the first device 210 to monitor the paging message, while the configuration information may indicate the first device 210 how to monitor the identification information and link the identification information to a tracking area.

In turn, the first device 210 monitors (380), from the second device 220, the paging message based on the received identification information.

In some embodiments, the second device 220 may receive (360) the paging message from the third device 230. The paging message may comprise an identity of the first device 210, an identity of the TA and an indication that the first device 210 support for TA based paging. The second device 220 may determine at least one cell serving the TA based on the identity of the TA. In turn, the second device 220 may transmit the paging message in the at least one cell.

In some embodiments, optionally, before receiving the identification information, the first device 210 may transmit (310), to the third device 230, an indication that first device 210 has capability for receiving the identification information based on the TA. In turn, the first device 210 may receive (320), from the third device 230, an indication that the receiving of the identification information is activated. In some embodiments, the first device 210 may receive the indication from the third device 230 via a Non-Access Stratum (NAS) signaling.

In some embodiments, prior to a soft switch of TA in the cell 222 of the second device 220, the first device 210 may receive (330), from the second device 220, configuration information about mapping between the identification information and the TA. For example, the first device 210 may receive the configuration information about the mapping via system information.

Hereinafter, the TA served by the cell 222 of the second device 220 prior to the soft switch is also referred to as a primary TA. For example, in embodiments where the cell 222 of the second device 220 is implemented as the second cell 122 in FIG. 1, the primary TA may be implemented as the second TA having TAC2.

In some embodiments, the first device 210 may receive the paging message based on the configuration information about mapping between the identification information and the primary TA.

In some embodiments, the cell 222 of the second device 220 may move within a border of a further TA and a soft switch of TA may be performed (340) in the cell 222 of the second device 220. For example, the further TA may comprise the first TA having TAC1 in FIG. 1. Upon the soft switch, the second device 220 may broadcast (350) further configuration information about mapping between further identification information and the further TA. Hereinafter, the TA served by the cell 222 of the second device 220 after the soft switch is also referred to as an additional TA. For example, in embodiments where the cell 222 of the second device 220 is implemented as the second cell 122 in FIG. 1, the additional TA may be implemented as the first TA having TAC1.

In some embodiments, for a device reselecting to the cell 222 of the second device 220, upon receiving the further configuration information about mapping between the further identification information and the additional TA, the device may receive a paging message for the additional TA based on the further configuration information. For example, if the terminal device 110 in FIG. 1 reselects to the cell 222 of the second device 220, the terminal device 110 may receive a paging message for the additional TA based on the further configuration information.

In some embodiments, if the cell 222 supports group wake-up signals (GWUS) in LTE IoT system, the identification information may comprise wake-up signals (WUS). The WUS may indicate to the first device 210 whether it should monitor a paging occasion. For example, the WUS may be either a sequence or bit(s).

In such embodiments, configuration information about mapping between default WUS and the primary TA may be transmitted from the second device 220. In addition, further configuration information about mapping between an additional WUS and the additional TA may be also transmitted from the second device 220. For example, the additional WUS may be configured as common parameter across all cells serving the TA. Otherwise, the additional WUS for the additional TA may be broadcasted in each cell.

In such embodiments, if the first device 210 receives the default WUS, the first device 210 may determine that the paging message is directed to the primary TA. If the TA where the first device 210 is located is different from the primary TA, the first device 210 may skip monitoring a channel carrying the paging message. On the other hand, if the first device 210 receives the additional WUS, the first device 210 may determine that the paging message is directed to the additional TA. If the TA where the first device 210 is located is different from the additional TA, the first device 210 may skip monitoring a channel (for example, PDSCH) carrying the paging message. In this way, false wake-up of the first device 210 may be avoided.

In embodiments where the cell 222 supports GWUS in LTE IoT system, alternatively, the identification information may comprise information about a resource for reception of the WUS.

In embodiments where the cell 222 supports GWUS in LTE IoT system, the identification information may comprise an offset between the WUS and a paging occasion (PO) for the first device 210. For example, instead of configuring WUS specific to a TA (for example, a certain WUS sequence corresponds to a certain TA), the second device 220 may configure different time offsets between WUS and a PO for the first device 210. For example, first WUS corresponding to TA1 may have time offset 1 to the PO, while second WUS corresponding to TA2 may have offset 2 to the same PO.

In some embodiments, if the cell 222 supports Paging Early indication (PEI), the identification information may comprise the PEI. The PEI may indicate to the first device 210 whether it should monitor a paging occasion. For example, the PEI may be either a sequence or bit(s).

In such embodiments, the second device 220 may configure TA specific PEI. Mapping between the TA and the PEI may be negotiated between the first device 210 and the third device 230 via NAS signaling. The second device 220 may broadcast the mapping between the TA and the PEI in system information. The mapping between the TA and the PEI may be based on use of at least one of the following: search space, code, sequence, or time offset.

In some embodiments, the identification information may comprise information about a resource for reception of the PEI.

In some embodiments, the identification information may comprise information about a search space for control information scheduling the paging message. For example, the second device 220 may configure different search spaces for paging over specific TAs.

Alternatively, in some embodiments, the identification information may comprise information about a resource carrying the paging message. The resource may comprise a resource on Physical Downlink Shared Channel (PDSCH). For example, resources carrying paging messages may be divided into two groups in time-frequency domain such that scheduling in a first group of resources corresponds to TA1, while scheduling in a scheduling in a second group of resources corresponds to TA2.

In some embodiments, the identification information may comprise an index of a TA. For example, downlink control information (DCI) in Physical Downlink Control Channel (PDCCH) scheduling the paging message may include an index of a TA. If the TA where the first device 210 is located is different from the TA indicated in DCI, the first device 210 may skip monitoring a channel (for example, PDSCH) carrying the paging message. In this way, false wake-up of the first device 210 may be avoided.

Alternatively, in some embodiments, the identification information may comprise a paging identity for scrambling the control information scheduling the paging message. The control information scheduling the paging message may comprise DCI. For example, DCI scheduling the paging message may be scrambled with a Paging Radio Network Temporary Identifier (P-RNTI) specific to a TA. For example, the P-RNTI specific to a TA may be determined as P-RNTI+TA ID. Alternatively, any other identity in unused RNTI space may be used for scrambling the control information.

In some embodiments, if the second device 220 utilizes non-anchor carriers, the identification information may comprise information about a non-anchor carrier carrying the paging message. For example, the second device 220 may configure mapping between TA and a non-anchor carrier, such that paging messages on some non-anchor carriers are only monitored by the first device 210 registered to a certain TA.

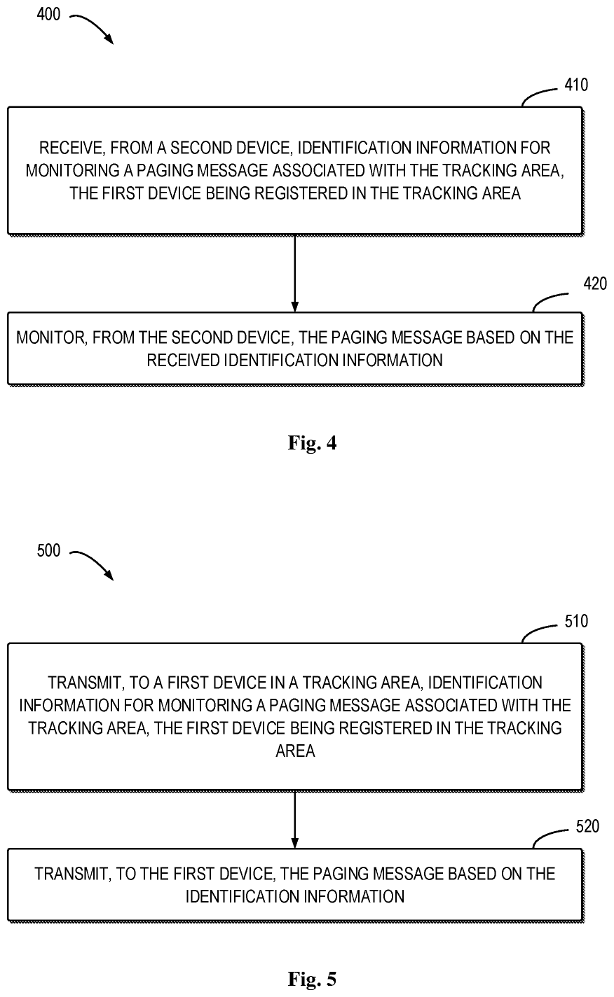

FIG. 4 shows a flowchart of an example method 400 implemented at a first device in accordance with some example embodiments of the present disclosure. For the purpose of discussion, the method 400 will be described from the perspective of the first device 210 with reference to FIG. 2.

At block 410, the first device 210 receives, from a second device, identification information for monitoring a paging message associated with the tracking area, the first device 210 being registered in the tracking area.

At block 420, the first device 210 monitors, from the second device, the paging message based on the received identification information.

In some embodiments, additionally, the first device 210 receives, from the second device, configuration information about mapping between the identification information and the tracking area. In such embodiments, the first device 210 monitors the paging message based on the configuration information.

In some embodiments, the identification information comprises at least one of following: a sequence of wake-up signals, information about a resource for reception of the wake-up signals, an offset between the sequence of wake up signals and a paging occasion for the first device, a paging early indication indicating whether the paging message is presented in the paging occasion, information about a search space for control information scheduling the paging message, information about a resource carrying the paging message, an index of the tracking area, a paging identity for scrambling the control information scheduling the paging message, or information about a non-anchor carrier carrying the paging message.

In some embodiments, additionally, the first device 210 transmits, to a third device, an indication that the first device has capability for receiving the identification information based on the tracking area. In turn, the first device 210 receives, from the third device, an indication that the receiving of the identification information is activated.

In some embodiments, additionally, the first device 210 reselects a cell, the cell broadcasting a code of the tracking area and a further code of a further tracking area and monitors the paging message for the tracking area.

In some embodiments, the first device comprises a terminal device, and the second device comprises an access network device.

In some embodiments, the third device comprises a core network device.

FIG. 5 shows a flowchart of an example method 500 implemented at a second device in accordance with some example embodiments of the present disclosure. For the purpose of discussion, the method 500 will be described from the perspective of the second device 220 with reference to FIG. 2.

At block 510, the second device 220 transmits, to a first device in a tracking area, identification information for monitoring a paging message associated with the tracking area, the first device being registered in the tracking area.

At block 520, the second device 220 transmits, to the first device, the paging message based on the identification information.

In some embodiments, additionally, the second device 220 transmits, to the first device, configuration information about mapping between the identification information and the tracking area. In such embodiments, the second device 220 transmits the paging message based on the configuration information.

In some embodiments, the identification information comprises at least one of following: a sequence of wake-up signals, information about a resource for reception of the wake-up signals, an offset between the sequence of wake up signals and a paging occasion for the first device, a paging early indication indicating whether the paging message is presented in the paging occasion, information about a search space for control information scheduling the paging message, information about a resource carrying the paging message, an index of the tracking area, a paging identity for scrambling the control information scheduling the paging message, or information about a non-anchor carrier carrying the paging message.

In some embodiments, the first device comprises a terminal device, and the second device comprises an access network device.

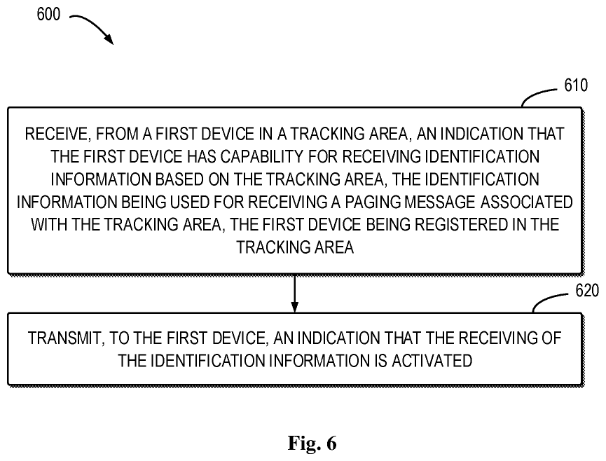

FIG. 6 shows a flowchart of an example method 600 implemented at a third device in accordance with some example embodiments of the present disclosure. For the purpose of discussion, the method 600 will be described from the perspective of the third device 230 with reference to FIG. 2.

At block 610, the third device 230 receives, from a first device in a tracking area, an indication that the first device has capability for receiving identification information based on the tracking area, the identification information being used for monitoring a paging message associated with the tracking area, the first device being registered in the tracking area with a second device.

At block 620, the third device 230 transmits, to the first device, an indication that the receiving of the identification information is activated.

In some embodiments, the first device comprises a terminal device, the second device comprises an access network device, and the third device comprises a core network device.

In some example embodiments, an apparatus capable of performing any of the method 400 (for example, a first apparatus) may comprise means for performing the respective steps of the method 400. The means may be implemented in any suitable form. For example, the means may be implemented in a circuitry or software module.

In some example embodiments, the first apparatus comprises: means for receiving, from a second device, identification information for monitoring a paging message associated with the tracking area, the first device being registered in the tracking area; and means for monitoring, from the second device, the paging message based on the received identification information.

In some embodiments, additionally, the first apparatus further comprises: means for receiving, from the second device, configuration information about mapping between the identification information and the tracking area. In such embodiments, the first apparatus monitors the paging message based on the configuration information.

In some embodiments, the identification information comprises at least one of following: a sequence of wake-up signals, information about a resource for reception of the wake-up signals, an offset between the sequence of wake up signals and a paging occasion for the first device, a paging early indication indicating whether the paging message is presented in the paging occasion, information about a search space for control information scheduling the paging message, information about a resource carrying the paging message, an index of the tracking area, a paging identity for scrambling the control information scheduling the paging message, or information about a non-anchor carrier carrying the paging message.

In some embodiments, additionally, the first apparatus further comprises: means for transmitting, to a third device, an indication that the first device has capability for receiving the identification information based on the tracking area. In such embodiments, the first apparatus further comprises: means for receiving, from the third device, an indication that the receiving of the identification information is activated.

In some embodiments, additionally, the first apparatus further comprises: means for reselecting a cell, the cell broadcasting a code of the tracking area and a further code of a further tracking area and monitors the paging message for the tracking area.

In some embodiments, the first device comprises a terminal device, and the second device comprises an access network device.

In some embodiments, the third device comprises a core network device.

In some example embodiments, an apparatus capable of performing any of the method 500 (for example, a second apparatus) may comprise means for performing the respective steps of the method 500. The means may be implemented in any suitable form. For example, the means may be implemented in a circuitry or software module.

In some example embodiments, the second apparatus comprises: means for transmitting, to a first device in a tracking area, identification information for monitoring a paging message associated with the tracking area, the first device being registered in the tracking area; and means for transmitting, to the first device, the paging message based on the identification information.

In some embodiments, additionally, the second apparatus further comprises: means for transmitting, to the first device, configuration information about mapping between the identification information and the tracking area. In such embodiments, the second device 220 transmits the paging message based on the configuration information.

In some embodiments, the identification information comprises at least one of following: a sequence of wake-up signals, information about a resource for reception of the wake-up signals, an offset between the sequence of wake up signals and a paging occasion for the first device, a paging early indication indicating whether the paging message is presented in the paging occasion, information about a search space for control information scheduling the paging message, information about a resource carrying the paging message, an index of the tracking area, a paging identity for scrambling the control information scheduling the paging message, or information about a non-anchor carrier carrying the paging message.

In some embodiments, the first device comprises a terminal device, and the second device comprises an access network device.

In some example embodiments, an apparatus capable of performing any of the method 600 (for example, a third apparatus) may comprise means for performing the respective steps of the method 600. The means may be implemented in any suitable form. For example, the means may be implemented in a circuitry or software module.

In some example embodiments, the third apparatus comprises: means for receiving, from a first device in a tracking area, an indication that the first device has capability for receiving identification information based on the tracking area, the identification information being used for monitoring a paging message associated with the tracking area, the first device being registered in the tracking area with a second device; and means for transmitting, to the first device, an indication that the receiving of the identification information is activated.

In some embodiments, the first device comprises a terminal device, the second device comprises an access network device, and the third device comprises a core network device.

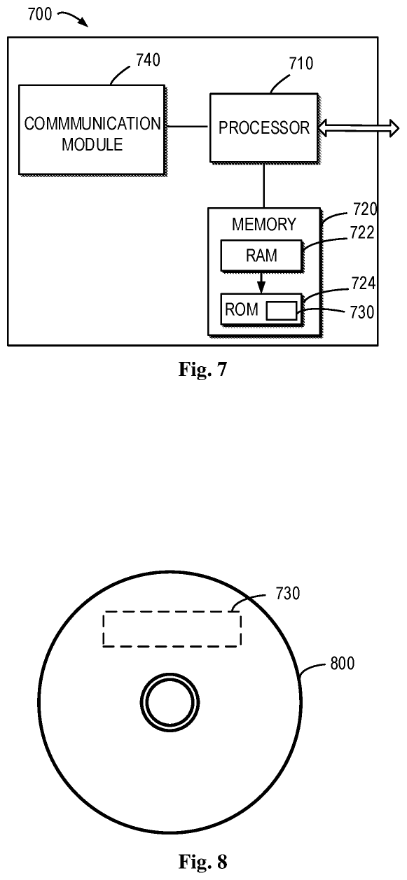

FIG. 7 is a simplified block diagram of a device 700 that is suitable for implementing embodiments of the present disclosure. The device 700 may be provided to implement the communication device, for example, the first device 210, the second device 220 or the third device 230 as shown in FIG. 2. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400, 500 and 600 as described above with reference to FIGS. 4-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device, comprising:
at least one processor; and
at least one memory including computer program code;
wherein the at least one memory and the computer program code are configured to, with the at least one processor, cause the first device in a tracking area to:
receive, from a second device, identification information for monitoring a paging message associated with the tracking area, the first device being registered in the tracking area; and
monitor, from the second device, the paging message based on the received identification information.

2. The first device of claim 1, wherein the at least one memory and the computer program code are configured to, with the at least one processor, further cause the first device to:
receive, from the second device, configuration information about mapping between the identification information and the tracking area; and
wherein the first device is caused to monitor the paging message by:
monitoring the paging message based on the configuration information.

3. The first device of claim 1, wherein the identification information comprises at least one of following:
wake-up signals,
information about a resource for reception of the wake-up signals,
an offset between the sequence of wake-up signals and a paging occasion for the first device,
a paging early indication,
information about a resource for reception of the paging early indication,
information about a search space for control information scheduling the paging message,
information about a resource carrying the paging message,
an index of the tracking area,
a paging identity for scrambling the control information scheduling the paging message, or
information about a non-anchor carrier carrying the paging message.

4. The first device of claim 1, wherein the at least one memory and the computer program code are configured to, with the at least one processor, further cause the first device to:
transmit, to a third device, an indication that the first device has capability for receiving the identification information based on the tracking area; and
receive, from the third device, an indication that the receiving of the identification information is activated.

5. The first device of claim 1, wherein the at least one memory and the computer program code are configured to, with the at least one processor, further cause the first device to:
reselect a cell, the cell broadcasting a code of the tracking area and a further code of a further tracking area; and
wherein the first device is caused to monitor the paging message by:
monitoring the paging message for the tracking area.

6. The first device of claim 1, wherein the first device comprises a terminal device, and the second device comprises an access network device.

7. The first device of claim 4, wherein the third device comprises a core network device.

8. A second device, comprising:
at least one processor; and
at least one memory including computer program code;
wherein the at least one memory and the computer program code are configured to, with the at least one processor, cause the second device to:
transmit, to a first device in a tracking area, identification information for monitoring a paging message associated with the tracking area, the first device being registered in the tracking area; and
transmit, to the first device, the paging message based on the identification information.

9. The second device of claim 8, wherein the at least one memory and the computer program code are configured to, with the at least one processor, further cause the second device to:
transmit, to the first device, configuration information about mapping between the identification information and the tracking area; and
wherein the second device is caused to transmit the paging message by:
transmitting the paging message based on the configuration information.

10. The second device of claim 8, wherein the identification information comprises at least one of following:
wake-up signals,
information about a resource for reception of the wake-up signals,
an offset between the sequence of wake up signals and a paging occasion for the first device,
a paging early indication,
information about a resource for reception of the paging early indication,
information about a search space for control information scheduling the paging message,
information about a resource carrying the paging message,
an index of the tracking area,
a paging identity for scrambling the control information scheduling the paging message, or
information about a non-anchor carrier carrying the paging message.

11. The second device of claim 8, wherein the first device comprises a terminal device, and the second device comprises an access network device.

12. A third device, comprising:
at least one processor; and
at least one memory including computer program code;
wherein the at least one memory and the computer program code are configured to, with the at least one processor, cause the third device to:
receive, from a first device in a tracking area, an indication that the first device has capability for receiving identification information based on the tracking area, the identification information being used for monitoring a paging message associated with the tracking area, the first device being registered in the tracking area; and
transmit, to the first device, an indication that the receiving of the identification information is activated.

13. The third device of claim 12, wherein the first device comprises a terminal device, the second device comprises an access network device, and the third device comprises a core network device.

14. A method, comprising:
receiving, at a first device from a second device, identification information for monitoring a paging message associated with the tracking area, the first device being registered in the tracking area; and
monitoring, from the second device, the paging message based on the received identification information.

15-20. (canceled)
